(19) United States
(12) Patent Application Publication
(10) Pub. No.: US 2010/0167671 A1
(43) Pub. Date: Jul. 1, 2010

(54) Wireless Communication Apparatus and Transmission Control Method Thereof

(75) Inventor: Satoshi Kawaji, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto (JP)

(21) Appl. No.: 12/528,301

(22) PCT Filed: Feb. 22, 2008
(86) PCT No.: PCT/JP2008/053059

§ 371 Date: Feb. 8, 2010

(30) Foreign Application Priority Data
Feb. 23, 2007 (JP) 2007-044069

(51) Int. Cl. H04B 1/04

(52) U.S. Cl. 455/127.5; 455/127.1

(57) ABSTRACT

A wireless communication apparatus of the present invention is provided with at least two amplification paths (2, 3, 4; 2, 3) capable of amplifying a transmission signal and having different power consumption, a selection unit 5, 6 for selecting one of the at least two amplification paths, and a control unit 11 for controlling the selection unit 5, 6 to select one of the at least two amplification paths and the transmission signal to be amplified in the selected amplification path in accordance with operational condition of the wireless communication apparatus. Thereby, power consumption is effectively reduced in accordance with conditions.

### CROSS REFERENCE TO RELATED APPLICATION

This application claims priority to and the benefit of Japanese Patent Application No. 2007-44069 filed on Feb. 23, 2007, the entire contents of which are incorporated herein by reference.

### TECHNICAL FIELD

The present invention relates to a wireless communication apparatus and a transmission control method thereof.

### BACKGROUND ART

A signal takes a form of wave like noise and PAR (Peak Average Ratio), a ratio of a peak power to an average power, becomes high by a modulation scheme using a multi-carrier represented by, for example, OFDM scheme such as Mobile WiMAX, UMB (Ultra Mobile Broadband), LTE (Long Term Evolution) and the likes. Although a modulation scheme such as QAM which changes both phase and amplitude may increase transmittable information with multi-values, it reduces a margin for noise, which leads a necessity for an increase in a required CNR (Carrier to Noise Ratio).

It is thus necessary to design a power amplifier of a transmission unit to have a high linearity and high maximum transmission power when a wireless communication apparatus employs the modulation scheme using a multi-carrier or QAM.

In addition, when a wireless communication apparatus using an adaptive modulation scheme which changes a modulation scheme in accordance with a channel condition supports a modulation scheme such as QAM which changes both phase and amplitude, it is necessary to design a power amplifier of a transmission unit to have a high linearity and high maximum transmission power in a similar manner.

However, when the power amplifier is designed to have a high linearity and high maximum transmission power, power consumption thereof increases in general. Thus there is a concern that duration of a battery is shortened when the wireless communication apparatus is a mobile terminal using the battery as its power source.

In order to solve such a problem, there is a known wireless communication apparatus using an adaptive modulation scheme which selects a modulation scheme with large modulation multi-values as well as controlling a power amplifier to operate in a class A when channel condition is good, while selecting a modulation scheme with small multi-values as well as controlling the power amplifier to operate in a class AB when the channel condition is poor, so as to attain higher efficiency of the power source (see Patent Document 1, for example). There are also a wireless communication apparatus that decides an adaptive modulation scheme and a transmission level by calculating CNR of a received signal (see Patent Document 2, for example) and a wireless communication apparatus that reduces input of a power amplifier to avoid distortion of output in a multi-value modulation (see Patent Document 3, for example).

Patent Document 1: Japanese Patent Application Laid-Open Publication No.09-83600

Patent Document 2: Japanese Patent Application Laid-Open Publication No. 2004-72666

Patent Document 3: Japanese Patent Application Laid-Open Publication No. 2005-175754

### SUMMARY OF INVENTION

### Technical Problem

The wireless communication apparatus disclosed in Patent Document 1 described above intends to improve the efficiency of the power source by controlling bias of the power amplifier to perform a class A operation or a class AB operation. The wireless communication apparatuses disclosed in Patent Document 2 and Patent Document 3 intend to reduce power consumption by controlling a transmission level and an input level of the power amplifier.

Since the known wireless communication apparatuses described above, however, have no difference in structure of the power amplifiers themselves, it cannot be expected to have sufficiently low power consumption.

On the other hand, a wireless communication apparatus using the adaptive modulation scheme generally uses the multi-value modulation scheme such as QAM when quality of a channel is good, while using a modulation scheme requiring small CNR such as pi/4-QPSK when the quality of the channel is poor.

For usages of the wireless communication apparatus, in a case where the apparatus is the mobile terminal, there are a usage to communicate in a power saving mode to extend time to use in consideration of remaining battery level or another usage using some applications (such as VoIP and transmission/reception of an e-mail) having no problem in communication at a comparatively low communication speed. For such usages, pi/4-QPSK scheme, for example, having the small number of modulation multi-values is sometimes used even in a good channel condition as a base station is located nearby. Use of the power amplifier having the high linearity for such usages is not efficient (over-performing) and wasting power consumption, leading to adverse affect on duration of the battery.

Such a problem is also caused in communication in a power saving mode and in communication at a low speed by use of a wireless communication apparatus using the power amplifier with high linearity and high maximum transmission power even when the adaptive modulation scheme is not used.

Thus, an object of the present invention in consideration of the problem is to provide a wireless communication apparatus and a transmission control method thereof that are capable of efficiently reducing power consumption in accordance with usage.

### Solution to Problem

In order to achieve the above object, the invention according to a first aspect is characterized in that a transmission control method of a wireless communication apparatus using an adaptive modulation scheme includes:

an amplification path selection step for selecting one amplification path or another amplification path having less power consumption than that of the one amplification path to amplify a transmission signal in accordance with operational condition of the wireless communication apparatus when communication is performed at a communication speed lower than a predetermined value and in a predetermined low modulation class; and

a transmission signal amplification step for amplifying the transmission signal in the selected amplification path.

The invention according to a second aspect is characterized in that, in the transmission control method of the wireless communication apparatus according to the first aspect,

the another amplification path is selected to amplify a transmission signal in the amplification path selection step when the operational condition of the wireless communication apparatus is in a power saving mode;

The invention according to a third aspect is characterized in that the transmission control method of the wireless communication apparatus according to the first aspect further includes:

a modulation class recognizing step for recognizing whether or not the modulation class is the predetermined low modulation class or a lower modulation class when communication is performed at the communication speed lower than the predetermined value; and

a modulation class changing step for changing the modulation class at least to the predetermined low modulation class when the modulation class is over the predetermined low modulation class as a result of recognition,

wherein the amplification path selection step is executed after execution of the modulation class changing step.

The invention according to a fourth aspect is characterized in that, in the transmission control method of the wireless communication apparatus according to the first aspect,

the one amplification path has a higher linearity than that of the another amplification path.

The invention according to a fifth aspect is characterized in that, in the transmission control method of the wireless communication apparatus according to the first aspect,

the communication at the communication speed lower than the predetermined value is voice communication.

Moreover, in order to achieve the above object, the invention according to a sixth aspect is characterized in that a transmission control method of the wireless communication apparatus includes:

an amplification path selection step for selecting one amplification path or another amplification path having less power consumption than that of the one amplification path to amplify a transmission signal in accordance with operational condition of the wireless communication apparatus; and

a transmission signal amplification step for amplifying the transmission signal in the selected amplification path.

The invention according to a seventh aspect is characterized in that, in the transmission control method of the wireless communication apparatus according to the sixth aspect,

the another amplification path is selected to amplify a transmission signal in the amplification path selection step when the operational condition of the wireless communication apparatus is in a power saving mode.

The invention according to an eighth aspect is characterized in that, in the transmission control method of the wireless communication apparatus according to the sixth aspect,

the one amplification path has higher linearity than that of the another amplification path.

The invention according to a ninth aspect is characterized in that, in the transmission control method of the wireless communication apparatus according to the seventh aspect,

communication at a communication speed lower than a predetermined value is voice communication.

Furthermore, in order to achieve the above object, the invention according to a tenth aspect is characterized in that a wireless communication apparatus for wireless communication using an adaptive modulation scheme includes:

at least two amplification paths having different power consumption and capable of amplifying the transmission signal;

a selection unit for selecting one of the at least two amplification paths; and

a control unit for controlling the selection unit to select one of the amplification paths and the transmission signal to be amplified in the selected amplification path in accordance with operational condition of the wireless communication apparatus when communication is performed at a communication speed lower than a predetermined value in a predetermined low modulation class.

Still furthermore, in order to achieve the above object, the invention according to an eleventh aspect is characterized in that a wireless communication apparatus includes:

at least two amplification paths having different power consumption and capable of amplifying the transmission signal;

a selection unit for selecting one of the at least two amplification paths; and

a control unit for controlling the selection unit to select one of the amplification paths and the transmission signal to be amplified in the selected amplification path in accordance with operational condition of the wireless communication apparatus.

### Effect of the Invention

According to the present invention, since one amplification path is selected from at least two amplification paths having different power consumption to amplify a transmission signal in accordance with operational condition of a wireless communication apparatus, it is possible to reduce power consumption effectively in accordance with using condition.

### BRIEF DESCRIPTION OF DRAWINGS

FIG. 1 is a block diagram illustrating constitution of a main section of a wireless communication apparatus according to a first embodiment of the present invention;

FIG. 2 is a flowchart illustrating an example of a communication control operation of the wireless communication apparatus of the first embodiment;

FIG. 3 is a block diagram illustrating constitution of a main section of a wireless communication apparatus according to a second embodiment of the present invention; and

FIG. 4 is a block diagram illustrating constitution of a main section of a wireless communication apparatus according to a third embodiment of the present invention.

### REFERENCE SIGNS LIST

1 power amplifier module
2, 3, 4 amplifier
5, 6 switch
11 control unit
21 power amplifier module
22, 23, 24 amplifier
25 first amplification system
26, 27, 28 amplifier
29 second amplification system
31, 32 switch
35 amplifier

### DESCRIPTION OF EMBODIMENTS

Embodiments of the present invention will be described with reference to the accompanying drawings.

### First Embodiment

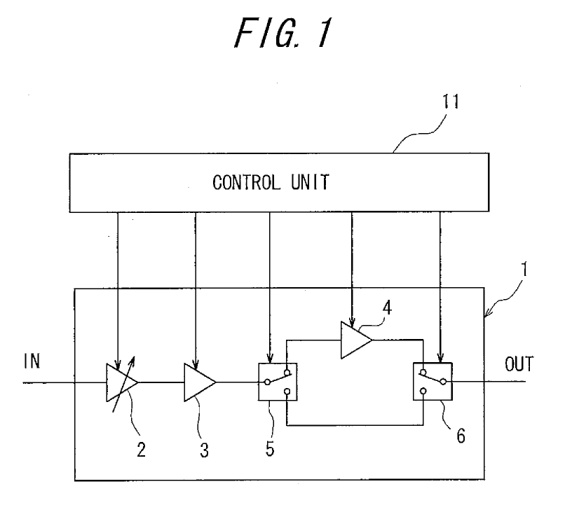

FIG. 1 is a block diagram illustrating constitution of a main section of a wireless communication apparatus according to a first embodiment of the present invention. The wireless communication apparatus performs wireless communication using an adaptive modulation scheme with pi/4-QPSK as a minimum modulation multi-value. A power amplifier module 1 has amplifiers 2, 3 and 4 forming three stages and switches 5 and 6 serving as a selection unit to bypass the amplifier 4 at a final stage. The amplifiers 2, 3 and 4 and the switches 5 and 6 are controlled by a control unit 11. The amplifiers 2, 3, and 4 are designed to obtain a high linearity overall, and the amplifier 2 at an initial stage has a variable gain. The switches 5 and 6 are controlled to select the amplifier 4 normally so that the amplifier 4 amplifies and outputs the output of the amplifier 3.

When it is not necessary to have the high linearity, the control unit 11 switches over the switches 5 and 6 to bypass the amplifier 4 at the final stage and turns off bias of the amplifier 4 isolated so as to cut down current consumption. In addition, the control unit 11 adjusts the gain of the amplifier 2 at the initial stage so as to compensate reduction in the gain due to the isolation of the amplifier 4. Thereby the gain and the output of the power amplifier module 1 are equal to those before the isolation of the amplifier 4 and there is almost no increase in current of the amplifiers 2 and 3. Accordingly, in this embodiment the amplifiers 2, 3 and 4 form one amplification path, whereas the amplifiers 2 and 3 form the other amplification path having less power consumption than that of the one amplification path.

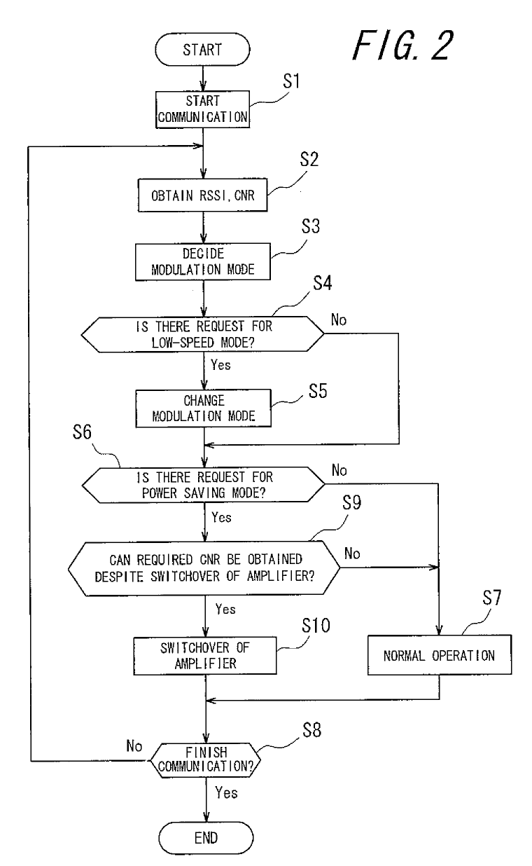

FIG. 2 is a flowchart illustrating an example of a communication control operation of the wireless communication apparatus according to this embodiment. When communication is started (step S1), RSSI (Receive Signal Strength Indicator) and CNR are obtained (step S2) and a modulation mode is determined based on a result of them (step S3).

Next, it is determined whether there is a request for a low-speed from, for example an application being executed (step S4). In a case where the application being executed is for example the one for voice communication or email which does not require a high speed data rate, it is determined that there is the request for the low-speed and the modulation mode decided at the step S3 is changed to another modulation mode with the less number of modulation multi-values (step S5), and then it is determined whether there is a request for a power saving mode (step S6).

On the other hand, when it is determined that there is no request for the low-speed mode at the step S4, the process flow proceeds to the step S6. The modulation mode changed at the step S5 is, for example, one class lower than that of the modulation mode decided at the step S3 in a modulation multi-value class (modulation class). When the modulation mode decided at the step S3 is pi/4-QPSK, since there is no modulation mode having smaller modulation multi-values in this embodiment, the process flow proceeds to the step S6 skipping the steps S4 and S5.

When it is determined that there is no request for the low-speed mode at the step S6, a normal operation is performed in the modulation mode decided at the step S3 or in the modulation mode changed at the step S5 (step S7) and then the process flow proceeds to the step S2 if the communication has not finished yet (step S8).

On the other hand, when it is determined that there is the request for the power saving mode at the step 56, it is determined whether a required CNR can be obtained even if the amplifier 4 is bypassed in the modulation mode decided at the step S3 or the modulation mode changed at the step S5 (step S9). Whether the required CNR can be obtained or not is determined based on tabulated values of actual CNR obtained in advance by experiments when the amplifier 4 is bypassed correspondingly to the modulation modes.

When it is determined that the required CNR cannot be obtained at the step S9, the process flow proceeds to the step S7 without bypassing the amplifier 4 to perform the normal operation in the modulation mode decided at the step S3 or in the modulation mode changed at the step S5, as it is necessary to have the high linearity.

On the other hand, when it is determined that the required CNR can be obtained, a switchover of the amplifier is executed by bypassing the amplifier 4 with the switches 5 and 6, turning off the bias of the amplifier 4 and adjusting the gain of the amplifier 2 (step S10), and then the process flow proceeds to the step S8.

As set forth above, in this embodiment in a case where there is a request for the low speed mode when the modulation mode decided based on RSSI and CNR is not in the minimum modulation class, the modulation mode is changed to the one in lower modulation class. In a case where there is further request for the power saving mode, it is determined whether the required CNR can be obtained in the modulation mode decided or changed even when the linearity is reduced by bypassing the amplifier 4. When it is determined that the required CNR can be obtained as a result, the amplifier 4 is bypassed and the bias of the amplifier 4 isolated is turned off. It is thus possible to efficiently reduce current consumption without adverse affect on the communication.

### Second Embodiment

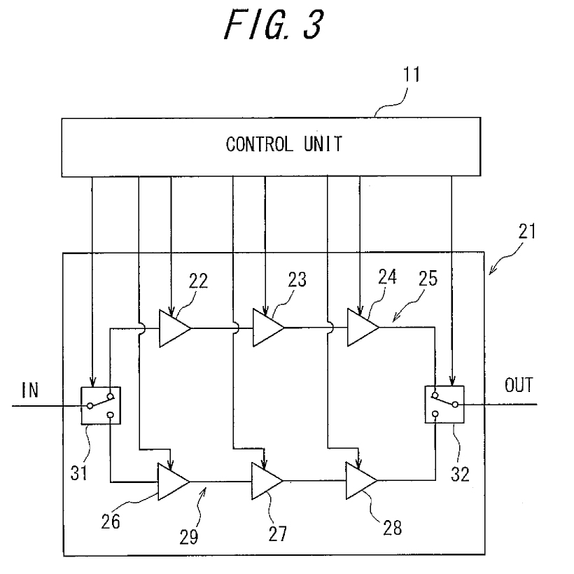

FIG. 3 is a block diagram illustrating constitution of a main section of a wireless communication apparatus according a second embodiment of the present invention. In this embodiment a power amplifier module 21 includes a first amplification system 25 having three stages of amplifiers 22, 23 and 24, a second amplification system 29 having three stages of amplifiers 26, 27 and 28, and switches 31 and 32 serving as a selection unit to change over the amplification systems. The amplifiers 22, 23, 24, 26, 27 and 28 and the switches 31 and 32 are controlled by a control unit 11.

The first amplification system 25 is designed to have a high linearity, whereas the second amplification system 29 is designed to have less linearity and power consumption than those of the first amplification system 25. The switches 31 and 32 are controlled to normally select the first amplification system 25 having the higher linearity. When being selected by the switches 31 and 32, the amplification system 25 and the second amplification system 29 are controlled to turn on the bias of each corresponding amplifier, while being controlled to turn off the bias of each corresponding amplifier when not selected. Accordingly, in this embodiment one amplification path is formed by the first amplification system 25, while the other amplification path is formed by the second amplification system 29.

In this embodiment, similarly to the first embodiment, when the modulation mode decided based on RSSI and CNR is not in the minimum modulation class and there is the request for the low-speed mode, the modulation mode is changed to the one in the lower modulation class. When there is further request for the power saving mode, it is determined whether the required CNR can be obtained even if the linearity is reduced by switching over to the second amplification system 29 in the modulation mode decided or changed. When it is determined that the required CNR can be obtained, the amplification system is changed over to the second amplification system 29 by the switches 31 and 32, and the bias of each amplifier 22, 23 and 24 in the first amplification system 25 isolated is turned off. Accordingly, in a similar manner to the first embodiment, it is possible to effectively reduce current consumption without adverse affect on the communication.

### Third Embodiment

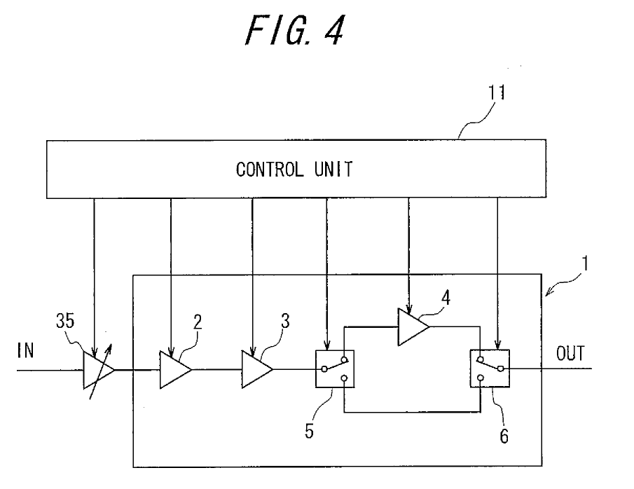

FIG. 4 is a block diagram illustrating constitution of a main section of a wireless communication apparatus according to a third embodiment of the present invention. In this embodiment an amplifier 35 for adjusting the gain is provided at an input stage of the power amplifier module 1 of the first embodiment, and the gain of the amplifier 2 at an initial stage in the power amplifier module 1 is fixed, so that the gain is adjusted by the amplifier 35 provided outside the power amplifier module 1 when the amplifier 4 is bypassed. Constitution of other elements is , the same that of the first embodiment. Accordingly, in the similar manner to the first embodiment, it is possible to effectively reduce current consumption without adverse affect on the communication in this embodiment.

It is to be understood that the present invention is not limited to the embodiments described above and various modification and changes may be made. For example, although the amplifier is switched over in the embodiments described above when there is the request for the power saving mode and the required CNR can be obtained even if the linearity is reduced, it is also possible to reduce the linearity in the modulation class having the minimum modulation multi-values regardless of whether there is the request for the power saving mode. In addition, even when the adaptive modulation scheme is not used, it is possible to reduce the linearity for the communication in the power saving mode or for the low-speed communication of the wireless communication apparatus using the power amplifier with the high linearity and high maximum transmission power. Moreover, the number of amplification paths having different power consumption is not limited to two but three or more systems may be provided to have functions similar to those in the embodiment described above so as to save power by appropriately selecting an optimum amplification path in accordance with conditions such as the communication speed and an operational mode.

1. A transmission control method of a wireless communication apparatus for wireless communication using an adaptive modulation scheme comprising:
an amplification path selection step for selecting one amplification path or another amplification path having less power consumption than that of the one amplification path to amplify a transmission signal in accordance with operational condition of the wireless communication apparatus when communication is performed at a communication speed lower than a predetermined value and in a predetermined low modulation class; and
a transmission signal amplification step for amplifying the transmission signal in the selected amplification path.

2. The transmission control method of the wireless communication apparatus according to claim 1, wherein the another amplification path is selected to amplify a transmission signal in the amplification path selection step when the operational condition of the wireless communication apparatus is in a power saving mode.

3. The transmission control method of the wireless communication apparatus according to 1, further comprising:
a modulation class recognizing step for recognizing whether or not the modulation class is the predetermined low modulation class or a lower modulation class when communication is performed at the communication speed lower than the predetermined value; and
a modulation class changing step for changing the modulation class at least to the predetermined low modulation class when the modulation class is over the predetermined low modulation class as a result of recognition,
wherein the amplification path selection step is executed after execution of the modulation class changing step.

4. The transmission control method of the wireless communication apparatus according to 1, wherein the one amplification path has higher linearity than that of the another amplification path.

5. The transmission control method of the wireless communication apparatus according to 1, wherein the communication at the communication speed lower than the predetermined value is voice communication.

6. A transmission control method of a wireless communication apparatus comprising:
an amplification path selection step for selecting one amplification path or another amplification path having less power consumption than that of the one amplification path to amplify a transmission signal in accordance with operational condition of the wireless communication apparatus; and
a transmission signal amplification step for amplifying the transmission signal in the selected amplification path.

7. The transmission control method of the wireless communication apparatus according to claim 6, wherein the another amplification path is selected to amplify a transmission signal in the amplification path selection step when the operational condition of the wireless communication apparatus is in a power saving mode.

8. The transmission control method of the wireless communication apparatus according to claim 6, wherein the one amplification path has higher linearity than that of the another amplification path.

9. The transmission control method of the wireless communication apparatus according to claim 7, wherein communication at a communication speed lower than a predetermined value is voice communication.

10. A wireless communication apparatus for wireless communication using an adaptive modulation scheme comprising:
at least two amplification paths having different power consumption and capable of amplifying a transmission signal;
a selection unit for selecting one of the at least two amplification paths; and
a control unit for controlling the selection unit to select one of the amplification paths and the transmission signal to be amplified in the selected amplification path in accordance with operational condition of the wireless communication apparatus when communication is performed at a communication speed lower than a predetermined value in a predetermined low modulation class.

11. A wireless communication apparatus comprising:
at least two amplification paths having different power consumption and capable of amplifying a transmission signal;
a selection unit for selecting one of the at least two amplification paths; and
a control unit for controlling the selection unit to select one of the amplification paths and the transmission signal to be amplified in the selected amplification path in accordance with operational condition of the wireless communication apparatus.
